(19) United States
(12) Patent Application Publication
(10) Pub. No.: US 2012/0064407 A1
(43) Pub. Date: Mar. 15, 2012

(54) POLYMER ACIDS AS PH-REDUCING BINDER OR AGENT FOR AQUEOUS LITHIUM-ION BATTERIES

(75) Inventors: Milburn Ebenezer Jacob Muthu, Breinigsville, PA (US); Monira Mamari, Allentown, PA (US); Chester Crane, Bangor, PA (US)

(73) Assignee: INTERNATIONAL BATTERY, INC., Allentown, PA (US)

(21) Appl. No.: 13/086,541

(22) Filed: Apr. 14, 2011

(51) Int. Cl. H01M 4/62; H01B 1/20; B05D 5/12; H01M 4/86

(52) U.S. Cl. 429/217; 252/182.1; 252/500; 427/126.3; 427/126.4; 427/126.6

(57) ABSTRACT

A positive electrode includes positive active material, conductive additive, water soluble polymer, water coated on the current collector. The slurry includes an active material, a water soluble binder, water, and a carboxylic acid-containing polymer sufficient to reduce the pH of the liquid slurry to a level below about 11.8. A method of forming an electrode is also disclosed.

### CROSS-REFERENCE TO RELATED APPLICATIONS

U.S. patent application Ser. No. 12/701,001, filed on Feb. 5, 2010, and U.S. patent application Ser. No. 12/836,126, filed on Jul. 14, 2010, are both fully incorporated herein by reference.

### FIELD OF INVENTION

The present invention relates to polymer acids as a pH-reducing binder or agent for aqueous lithium-ion batteries.

### BACKGROUND

Aqueous processing of lithium transition metal oxide cathodes, such as LiCoO₂, LiNiO₂, and LiNiCoAlO₂, for battery electrodes is difficult to achieve because the pH of the resulting slurry is typically over 11.8. The high pH results in metal dissolution and degradation of the performance of the cathode materials. The high pH also affects the dispersion of the active material, adhesion to the current collector, and the micro-structure of the current collector. There have been attempts to use carboxylic acid salt (carboxylate) to reduce pH of a slurry. The base component of the salt, however, adversely affects the ability to tune the pH. Accordingly, it would be beneficial to provide a mechanism for introducing a carboxylic acid to the slurry without adversely affecting the properties of the oxide-based cathode material.

### SUMMARY OF THE INVENTION

The present invention provides a positive electrode comprising a positive active material dispersed in an aqueous medium and coated onto the current collector. The slurry consists essentially of an active material, a water soluble binder, water, and a carboxylic acid-containing polymer sufficient to adjust the pH of the slurry to a level above 6 and below about 11.8.

The invention further provides a positive electrode manufactured according to the process of forming a slurry that consists essentially of a positive active material, a water soluble binder, water, and a carboxylic acid-containing polymer sufficient to adjust the pH of the slurry to a level above 6.0 and below about 11.8; coating the slurry onto a current collector; and drying the slurry.

The invention further comprises a method comprising the steps of: forming a slurry consisting essentially of a positive active material, a water soluble binder, and water; adding a sufficient amount of a carboxylic acid-containing polymer to the slurry to adjust the pH of the slurry to a level above 6.0 and below about 11.8; coating the slurry onto a current collector; and drying the slurry to form an electrode.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings certain embodiments of the present invention. It should be understood, however, that the invention is not limited to the precise arrangements and instrumentalities shown. In the drawings:

FIG. 1 is a schematic view of a battery formed in a jellyroll configuration according to an exemplary embodiment of the present invention;

FIG. 1A is a schematic view of the battery of FIG. 1 with the electrolyte;

FIG. 2 is a cross-sectional representation of a prismatic electrochemical cell according to an exemplary embodiment of the present invention;

FIG. 3 is a schematic representation of a positive electrode, a separator and a negative electrode-bi-cell configuration of the exemplary embodiment illustrated in FIG. 1;

FIG. 4 is a flowchart illustrating exemplary steps to form an electrode according to an exemplary embodiment of the present invention;

FIG. 5 is a graph illustrating a charge/discharge curve of electrical potential vs. time for an exemplary lithium metal half-cell manufactured using an aqueous process according to the present invention; and

FIG. 6 is a graph illustrating a charge/discharge curve of electrical potential vs. Spec. capacity (mAh/g) for an exemplary lithium metal half-cell manufactured using an aqueous process according to the present invention.

### DETAILED DESCRIPTION OF THE PREFERRED EMBODIMENTS

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It should be understood that the drawings may not be drawn exactly to scale. In the drawings, similar reference numbers are used for designating similar elements throughout the several figures.

In the claims which accompany this specification, steps recited in the claims may be identified with letters (e.g., a), b), etc.). It should be understood that such letters are not intended to limit the order in which the claimed steps must be performed, unless such order is specified in the claims.

The following describes particular embodiments of the present invention. It should be understood, however, that the invention is not limited to the embodiments detailed herein. The invention pertains to the manufacture of electrodes used in Li-ion batteries. Electrodes manufactured according to the present invention include a current collector that is coated with an electrode mix slurry that is coated onto the current collector and then dried.

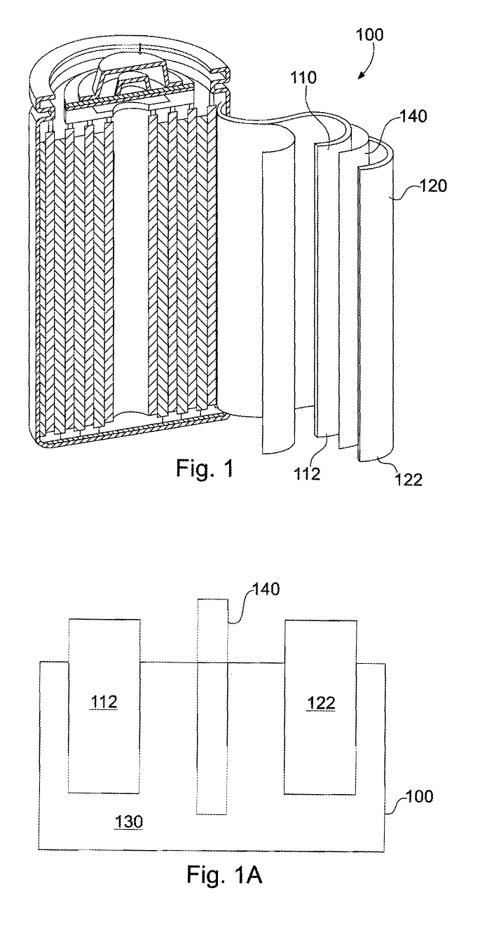

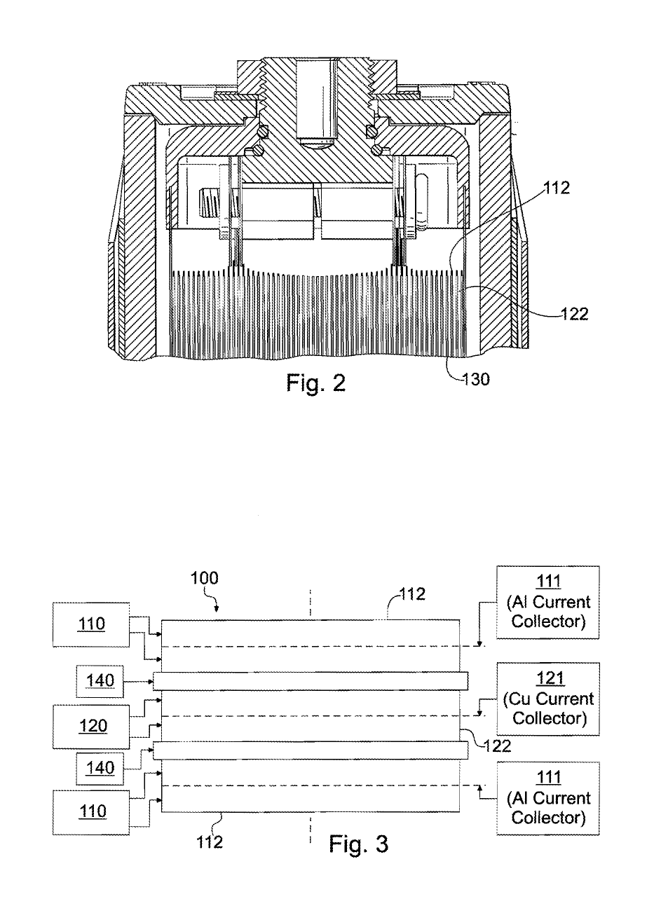

Referring to FIGS. 1 and 1A, a rechargeable lithium ion battery 100 according to an exemplary embodiment of the present invention includes a positive electrode 112 formed from a positive electrode mix 110, a negative electrode 122 formed from a negative electrode mix 120, and an electrolyte 130. A separator 140 separates positive electrode 112 from negative electrode 122. While FIG. 1 illustrates battery 100 formed in a “jellyroll” configuration, those skilled in the art will recognize that other formations, such as, for example, a prismatic configuration, which is illustrated in FIG. 2, may also be used within the teaching of the present invention.

In an exemplary embodiment, electroactive positive electrode mix 110 comprises a positive active material, a water-soluble binder (aqueous binder), and a carboxylic acid-containing polymer to reduce the pH of the slurry to a desired level. Optionally, a water-soluble thickener may be added to adjust the viscosity of the slurry and a conductive additive may be used. All of these materials are mixed together in a water medium to make a slurry.

In an exemplary embodiment, the positive active material is preferably selected from the group consisting of LiNiCoAlO₂, LiMn₂O₄, LiNi_{y}CoₓM_{z}O, where M=Mn, Al, Sn, In, Ga or Ti, 0.15<x<0.5, 0.5<y<0.8 and 0<z<0.15, Li[Li_{(1-2y/3}Ni_{y}Mn_{(2-y/3)}]O₂, Li[Li_{(1-y)/3}Co_{y}Mn_{(2-2y)/3}]O₂ and Li[Ni_{y}Co_{1-2y}Mn_{y}]O₂ where x=(2−y)/3 and 0<y<0.5, LiNiCoO₂.MnO₂, lithium rich compounds Li_{1+y}(Ni_{1/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}Co_{0.2}Mn_{0.3})_{1-y}O₂, where x=0-0.33, y=(x/(2+x)), and LiMPO₄, where M is one or more of the first row transition-metal cations selected from the group consisting of V, Cr, Mn, Fe, Co, Ni, and combinations thereof.

In an exemplary embodiment, the binder is a water soluble polymer, preferably selected from the group consisting of carboxymethylcellulose, (CMC), poly vinyl alcohol, polyvinylpyrrolidone, poly acrylic acid, polymethacrylic acid, polyethylene oxide, polyacrylamide, poly-N-isopropylearylamide, poly-N,N-dimethylacrylamide, polyethyleneimine, polyoxyethylene, polyvinylsulfonic acid, poly(2-methoxyethoxyethoxyethylene), styrene butadiene rubber (SBR), butadiene-acrylonitrile rubber (NBR), hydrogenated NBR (HNBR), epichlorhydrin rubber (CHR) and acrylate rubber (ACM), or combinations thereof.

In an exemplary embodiment, the optional water-soluble thickener may be selected from the group consisting of natural cellulose, physically and/or chemically modified cellulose, natural polysaccharides, chemically and/or physically modified polysaccharides, carboxymethyl cellulose, hydroxy methyl cellulose and methyl ethyl hydroxy cellulose.

In an exemplary embodiment, the optional conductive additive may be carbon black, actylene black, graphite, or another suitable conductive material known in the art.

In an exemplary embodiment, the carboxylic acid-containing polymer is preferably selected from the group consisting of polylactic acid (PLA), polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

The positive electrode mix 110 is prepared by mixing between about 10 and about 90 percent (by weight) of active material, between about 0 and about 20 percent (by weight) of conductive additive, and between about 1 and about 10 percent (by weight) of binder polymer. Water is added to form the slurry. Between about 0 and about 10 percent (by weight) of the thickener may be added to the slurry.

If a water soluble binder having sufficient viscosity is used, it is not necessary to add a thickening agent to control the viscosity of the slurry. The composition and use of such binders is more fully discussed in U.S. application Ser. No. 12/701,001, filed Feb. 5, 2010.

As noted above, high pH is a recognized problem in many positive electrode mixes. It is not uncommon for a pH to be in the range of 12.0-13.0 for a slurry having the composition described in this exemplary embodiment. To control the pH of the positive active material mix 110, the carboxylic acid-containing polymer is added to the slurry very slowly until the pH of the slurry is between about 6.0 and about 11.8 and most preferably between about 9.0 and below about 10.0. Preferrably, the pH of the slurry is frequently measured while the carboxylic acid-containing polymer is being added. The reduced pH of the slurry helps to improve the dispersion of active materials and suppresses potential reactions between other elements of the slurry and the current electrode. In an exemplary embodiment, the carboxylic acid-containing polymer is added as a last step in forming the slurry.

It should be noted that not all positive electrode mixes require pH adjustment. For example, pH adjustment may not be necessary in positive electrode mixes in which the active material is LiFePO₄ or LiMn₂O₄.

When the slurry is at the desired pH, the slurry is coated onto a current collector, such as, for example, aluminum foil, carbon coated aluminum foil, or nickel foil, and dried to form a positive electrode.

Electroactive negative electrode mix 120 includes a mix of negative active material, the water soluble binder, and, optionally, a conductive additive and/or a thickener. All of the materials are mixed together in a water medium to make a slurry.

In an exemplary embodiment, the negative active material is selected from the group consisting of graphite, hard carbon, silicon, silicon alloy, tin, tin alloy, and lithium titanate. In an exemplary embodiment, the optional conductive additive material is selected from the group consisting of carbon black, actylene black and graphite. Suitable exemplary materials for the binder and the optional thickener are both disclosed above with respect to the positive electrode.

Negative active material mix 120 is prepared by mixing between about 10 and about 95 percent (by weight) of active material, between about 0 and about 20 percent (by weight) of conductive additive, and between about 1 and about 10 percent (by weight) of binder polymer. Water is added to the mix to form a slurry. Between about 0 and about 10 percent (by weight) of the thickener may be added to the slurry. Similar to the positive electrode slurry, the water soluble binder may optionally be used to make the negative electrode slurry without adding any thickening agent to control the viscosity.

In this exemplary embodiment, the negative electrode slurry pH is between about 7 and about 10 and does not need polymeric acids to control the pH of the slurry. The slurry is coated on a copper current collector and dried to form a negative electrode.

After the positive electrode and the negative electrode are formed, the electrodes are used to form a battery 100, schematically illustrated in FIG. 3. A positive electrode 110 and a negative electrode 120, manufactured according to the present invention, are separated by a porous separator 140, as is well known in the art. Battery 100 may be a cylindrical battery as shown in FIG. 1, or, alternatively, battery 100 may be a large format prismatic battery as shown in FIG. 2.

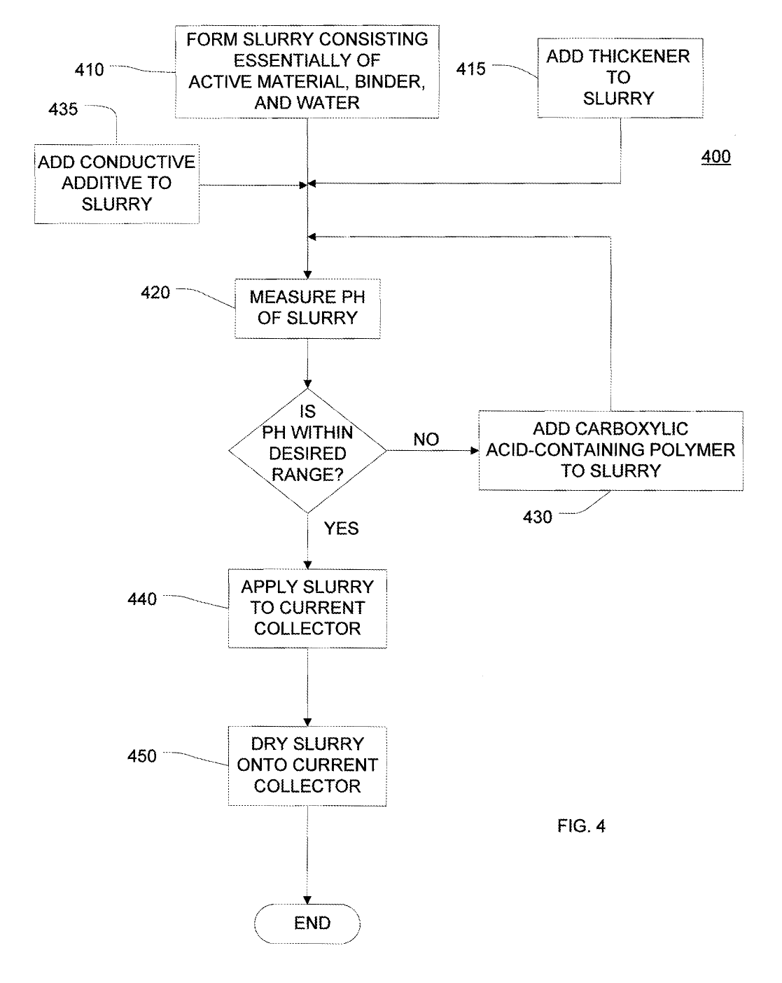

Referring to the flow chart 400 of FIG. 4, an exemplary method of manufacturing the positive electrode includes, in step 410, forming a slurry comprising the active material, the water soluble binder, and water. Optionally, in step 415, a thickener is added to the slurry. In step 435, the conductive additive may be added to the slurry. In step 420, the pH of the slurry is measured, and in step 430, a sufficient amount of the carboxylic acid-containing polymer is added to the slurry to adjust the pH of the slurry to a desired level. In step 440, after the pH of the slurry has reached a desired level, the slurry is applied to a positive current collector and in step 450, the slurry is dried, adhering to the current collector.

### Example

The following is an example of a positive electrode mix, which is provided purely as an illustration and should not be interpreted as limiting the scope of the invention in any way. In this example, the binder was poly acrylonitrile-co-acrylamide polymer, the positive active material was LiNiCoAlO₂ powder, the conductive additive was carbon black (for example, Super P® carbon black, manufactured by Timcal Graphite & Carbon of Bodio, Switzerland) and the carboxylic acid-containing polymer was polymeric acid.

The binder was first dissolved in water (at a ratio of about 15-25% solids by weight). The conductive additive and active material were then introduced to the binder-water solution and thoroughly mixed. At the conclusion of mixing, the pH of the slurry was measured and determined to be about 12.4. The carboxylic acid-containing polymer was then mixed into the slurry as a 1% poly acrylic acid-water solution until the pH of the slurry was reduced to between 10.0 and 11.0. The slurry was mixed again for about an hour. The homogeneously mixed slurry was then coated on the aluminum current collector or a carbon coated aluminum current collector 111 to form positive electrode 112. Positive electrode 112 was cut into an appropriate size and dried in a vacuum oven to reduce moisture content.

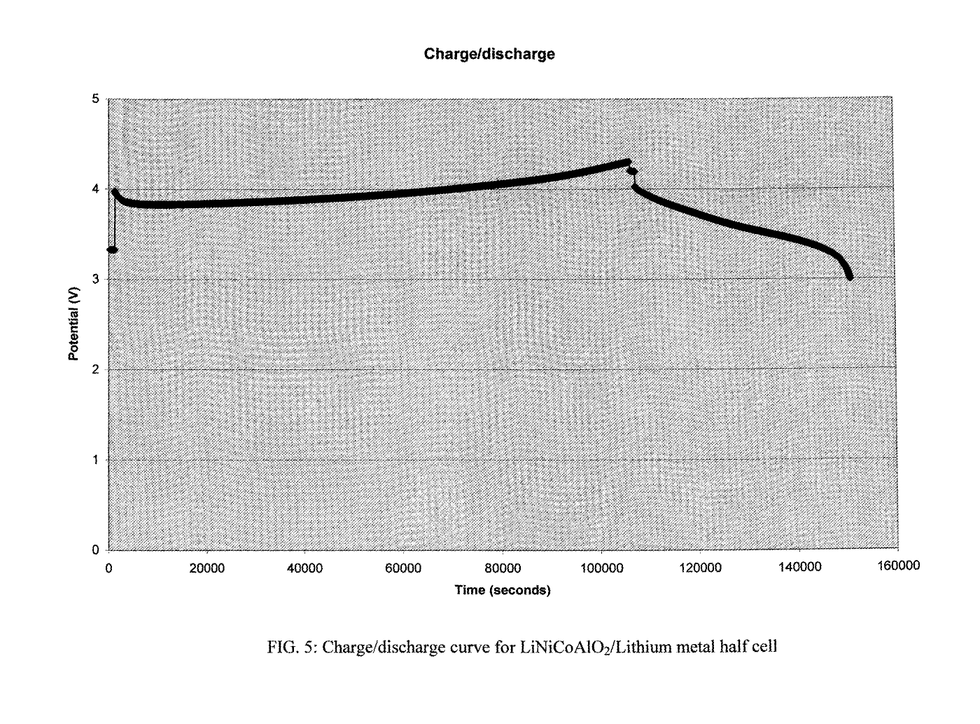

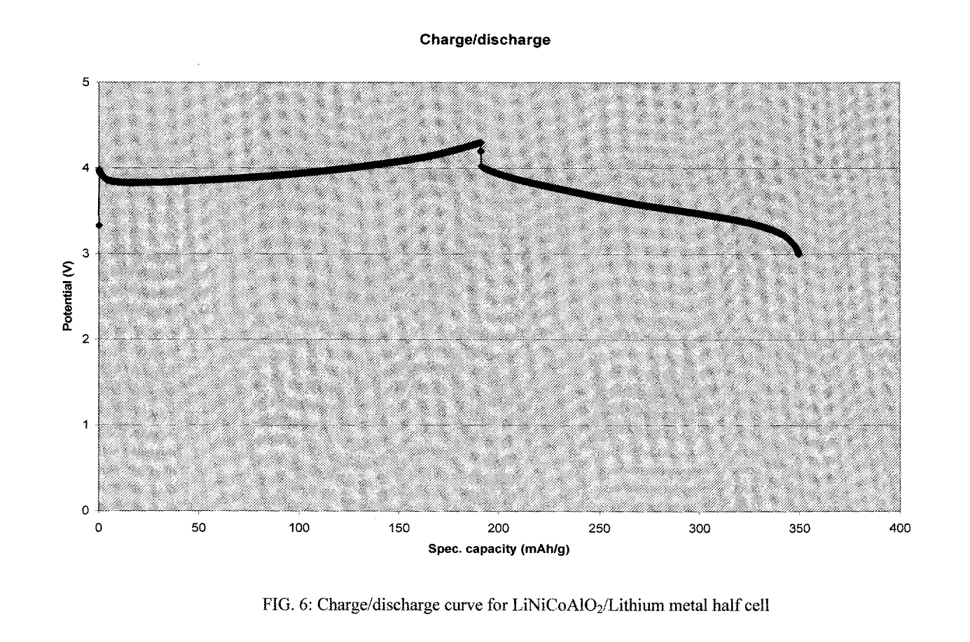

Lithium half-cells having electrodes created using the example set forth above were built for capacity evaluation. The half-cells were then filled with electrolyte 130, sealed, and then tested. FIGS. 5 and 6 show charge/discharge curves for the half-cells made in accordance with the example set forth above. As shown in FIGS. 5 and 6, the charge and discharge characteristics of the half-cells were within expected ranges, which confirms that the pH adjusting polymer maintained the pH of the slurry within an acceptable range without any significant detrimental effects on performance.

While the principles of the invention have been described above in connection with preferred embodiments, it is to be clearly understood that this description is made only by way of example and not as a limitation of the scope of the invention.

1. A slurry for coating a current collector of an electrode, the slurry comprising:
an active material;
a water-soluble polymer binder;
water; and
a carboxylic acid-containing polymer, provided in a quantity sufficient to reduce a pH of the slurry to no greater than 11.8;
wherein the pH of the slurry would be greater than 11.8 in the absence of the carboxylic acid-containing polymer.

2. (canceled)

3. The slurry according to claim 1, wherein the slurry consists essentially of the active material, the water-soluble polymer binder, water, the carboxylic acid-containing polymer and a conductive additive.

4. The slurry according to claim 1, wherein the slurry consists essentially of the active material, the water-soluble polymer binder, water, the carboxylic acid-containing polymer, the conductive additive and a thickener.

5. The slurry according to claim 1, wherein the active material comprises one or more lithium transition metal oxide based positive active materials.

6. The slurry according to claim 3, wherein the active material is selected from the group consisting of LiNiCoAlO₂, LiMn₂O₄, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂ where x=(2−y)/3 and 0<y<0.5, LiNiCoO2.MnO2, lithium rich compounds Li_{1+y}(Ni_{1/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}Co_{0.2}Mn_{0.3})_{1-y}O₂, where x=0-0.33, y=(x/(2+x)), and LiMPO₄, where M is one or more of the first row transition-metal cations selected from the group consisting of V, Cr, Mn, Fe, Co, Ni, and combinations thereof.

7. The slurry according to claim 1, wherein the carboxylic acid-containing polymer is selected from the group consisting of polylactic acid, polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

8. A positive electrode manufactured according to the process of:
a) forming a slurry having a pH greater than 11.8 and comprising a positive active material, a water soluble polymer binder, water, and optionally a conductive additive;
b) adding a carboxylic acid-containing polymer to the slurry to reduce the pH to no greater than 11.8;
c) coating the slurry onto a current collector; and
d) drying the slurry onto the current collector.

9. (canceled)

10. The positive electrode according to claim 8, wherein step a) comprises forming a slurry having a pH greater than 11.8 and consisting essentially of a positive active material, a water soluble polymer binder, and water.

11. The positive electrode according to claim 8, wherein step a) comprises forming a slurry having a pH greater than 11.8 and consisting essentially of a positive active material, a water soluble polymer binder, water and optionally, a thickener.

12. The positive electrode according to claim 8, wherein step b) comprises adding a carboxylic acid-containing polymer selected from the group consisting of polylactic acid, polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

13. The positive electrode according to claim 8, wherein step a) comprises forming a slurry having a pH greater than 11.8 and comprising a lithium transition metal oxide based positive active material, a water soluble polymer binder, water.

14. The slurry according to claim 8, wherein step a) comprises forming a slurry having a pH greater than 11.8 and comprising a water soluble polymer binder, water, and an active material selected from the group consisting of LiNiCoAlO₂, LiMn₂O₄, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂ where x=(2−y)/3 and 0<y<0.5, LiNiCoO2.MnO2, lithium rich compounds Li_{1+y}(Ni_{l/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}Co_{0.2}Mn_{0.3})_{1-y}O₂, where x=0-0.33, y=(x/(2+x)), and LiMPO₄, where M is one or more of the first row transition-metal cations selected from the group consisting of V, Cr, Mn, Fe, Co, Ni, and combinations thereof.

15. A method comprising the steps of:
a) forming a slurry having a pH greater than 11.8 and comprising a positive active material, a water soluble binder and water;
b) adding a sufficient amount of a carboxylic acid-containing polymer to the slurry to reduce a pH of the slurry to no greater than 11.8;
c) coating the slurry onto a current collector; and
d) drying the slurry while coated on the current collector.

16. The method according to claim 15, wherein step b) comprises measuring the pH of the slurry while adding the carboxylic acid-containing polymer.

17. The method according to claim 15, wherein step b) comprises adding a sufficient amount of a carboxylic acid-containing polymer to the slurry to reduce a pH of the slurry to between about 9.0 and about 11.8.

18. The method according to claim 15, wherein step b) comprises adding a sufficient amount of a carboxylic acid-containing polymer to the slurry to reduce a pH of the slurry to between about 9.0 and about 10.0.

19. (canceled)

20. The method according to claim 15, wherein steps a) and b) are performed in the absence of a thickener.

21. The method according to claim 15, wherein step b) comprises adding the carboxylic acid-containing polymer selected from the group consisting of polylactic acid, polyacrylic acid, polysuccinic acid, poly maleic acid and anhydride, poly furoic (pyromucic acid), poly fumaric acid, poly sorbic acid, poly linoleic acid, poly linolenic acid, poly glutamic acid, poly methacrylic acid, poly licanic acid, poly glycolic acid, poly aspartic acid, poly amic acid, poly formic acid, poly acetic acid, poly propoionic acid, poly butyric acid, poly sebacic acid, and copolymers thereof.

22. The method of claim 15, wherein step a) comprises forming a slurry having a pH greater than 11.8 and comprising a lithium transition metal oxide based positive active material, a water soluble polymer binder, and water.

23. The method of claim 15, wherein step a) comprises forming a slurry having a pH greater than 11.8 and comprising a water soluble polymer binder, water, and an active material selected from the group consisting of LiNiCoAlO₂, LiMn₂O₄, LiNi_{y}CoₓM_{z}O, where M=Mn, Al, Sn, In, Ga or Ti and 0.15<x<0.5, 0.5<y<0.8 and 0<z<0.15, Li[Li_{(1-2y)/3}Ni_{y}Mn_{(2-y)/3}]O₂, Li[Li_{(1-y)/3}Co_{y}Mn_{(2-2y)/3}]O₂ and Li[Ni_{y}Co_{1-2y}Mn_{y}]O₂ where x=(2−y)/3 and 0<y<0.5, LiNiCoO2.MnO2, lithium rich compounds Li_{1+y}(Ni_{1/3}Co_{1/3}Mn_{1/3})_{1-y}O₂, where x=0-0.33, y=(x/(2+x)) and xLi₂MnO₃(1−x)Li(NiCoMn)O₂ and Li_{(1+y)}(Ni_{0.5}Co_{0.2}Mn_{0.3})_{1-y}O₂, where x=0-0.33, y=(x/(2+x)), and LiMPO₄, where M is one or more of the first row transition-metal cations selected from the group consisting of V, Cr, Mn, Fe, Co, Ni, and combinations thereof.
